(19) United States
(12) Patent Application Publication
(10) Pub. No.: US 2012/0249897 A1
(43) Pub. Date: Oct. 4, 2012

(54) ELECTROOPTIC DEVICE, PROJECTION DISPLAY DEVICE, AND ELECTRONIC DEVICE

(75) Inventors: Satoshi Ito, Eniwa-shi (JP); Shigefumi Yamaji, Chitose-shi (JP)

(73) Assignee: Seiko Epson Corporation, Tokyo (JP)

(21) Appl. No.: 13/429,820

(22) Filed: Mar. 26, 2012

(30) Foreign Application Priority Data
Mar. 29, 2011 (JP) 2011-073545

(51) Int. Cl. G02F 1/13357; G02F 1/1343

(52) U.S. Cl. 349/5; 349/139

(57) ABSTRACT

When electrically connecting a second electrode layer and a pixel electrode through a plug electrode provided in a hole of an interlayer insulation film, the plug electrode is formed in such a manner as to fill the contact hole formed in the first insulation film, and then a second insulation film is formed. Then, the second insulation film is polished from the surface side to expose the plug electrode, and thereafter a pixel electrode is formed on the surface side of the second insulation film.

### BACKGROUND

1. Technical Field

The present invention relates to an electrooptic device in which a conductive layer which conducts through a contact hole is formed on an element substrate, a projection display device, and an electronic device.

2. Related Art

On an element substrate for use in electrooptic devices, such as liquid crystal devices or organic electroluminescence devices, pixels having pixel electrodes are disposed in the shape of a matrix, and a pixel transistor containing a field effect transistor is constituted in each of the plurality of pixels. Moreover, the element substrate has a conductive portion in which conductive layers conduct through a contact hole formed in an insulation film. In the conductive portion, when the formation of irregularities originating from the contact hole in the conductive layer on the upper side is not preferable, a structure is employed in which a plug electrode filling the contact hole is provided, and the conductive films are electrically connected through the plug electrode (e.g., JP-A-2010-262200 and JP-A-2002-244153).

In order to form the conductive portion utilizing the plug electrode, in general, an interlayer insulation film 49 having contact holes 49s on the upper side of first conductive layers 7s is first formed as illustrated in FIG. 8A, and thereafter a plug electrode forming conductive film 8s, such as tungsten, is thickly formed by a sputtering method as illustrated in FIG. 8B. Next, the plug electrode formation conductive film 8s is polished from the surface side to leave plug electrodes 8t in the contact holes 49s as illustrated in FIG. 8C, and thereafter second conductive layers 9s are formed on the surface of the interlayer insulation film 49 in FIG. 8D.

However, in the configuration described with reference to FIGS. 8A to 8D, the contact holes 49s are formed in the interlayer insulation film 49, and then the contact holes 49s are filled with the plug electrode forming conductive film 8s, such as tungsten, which causes a problem in that the film formation of the plug electrode forming conductive film 8s or the polishing thereof take considerable time. Specifically, in order to certainly fill the contact holes 49s with the plug electrode forming conductive film 8s, it is necessary to determine a thickness d8s of the plug electrode forming conductive film 8s to be sufficiently larger than a thickness d49 (a depth d49s of the contact holes 49s) of the interlayer insulation film 49. In order to form the plug electrode forming conductive film 8s having such a large thickness by a sputtering method, a considerable film formation time is required. Moreover, when the thickness d8s of the plug electrode forming conductive film 8s is set to be sufficiently large, a considerable polishing time is required.

### SUMMARY

An advantage of some aspects of the invention is to provide a method for manufacturing an electrooptic device in which a polishing time or a film formation time of a plug electrode forming conductive film can be shortened when conducting conductive layers by plug electrodes provided in holes formed in an insulation film, an electrooptic device manufactured by the manufacturing method, a projection display device, and an electronic device.

In order to solve the above-described problems, a method for manufacturing an electrooptic device according to an aspect of the invention includes: a first conductive layer formation process for forming a first conductive layer on one surface of a substrate; a first insulation film formation process for forming a first insulation film on a side opposite to the substrate to the first conductive layer; a contact hole formation process for forming a contact hole which reaches the first conductive layer in the first insulation film; a plug electrode forming conductive film formation process for forming a plug electrode forming conductive film having a film thickness larger than that of the first insulation film at a side opposite to the substrate to the first insulation film; a plug electrode formation process for patterning the plug electrode forming conductive film in such a manner that the plug electrode forming conductive film remains at least in the contact hole to form a plug electrode; a second insulation film formation process for forming a second insulation film at a side opposite to the substrate to the first insulation film and the plug electrode; a polishing process for polishing the second insulation film to expose the plug electrode from the second insulation film; and a second conductive layer formation process for forming a second conductive layer which conducts to the plug electrode at a side opposite to the substrate to the second insulation film.

An electrooptic device according to a first aspect of the invention has: a first conductive layer provided on one surface side of a substrate; a first insulation film provided at a side opposite to the substrate to the first conductive layer and having a contact hole which reaches the first conductive layer; a plug electrode having a first electrode portion filling the inside of the contact hole and a second electrode portion projecting from the surface of the first insulation film; a second insulation film provided at a side opposite to the substrate to the first insulation film and constituting a continuous flat surface with the plug electrode; and a second conductive layer provided at a side opposite to the substrate to the second insulation film and conducting to the plug electrode, in which the second electrode portion is patterned in such a manner as to be provided also on the periphery of the contact hole as viewed in plan.

In the electrooptic device according to the aspect of the invention and the method for manufacturing the same, when electrically connecting the first conductive layer and the second conductive layer through the plug electrode provided in the hole of the insulation film, the plug electrode is formed in such a manner as to fill the contact hole formed in the first insulation film, and thereafter the second insulation film is formed. Then, the second insulation film is polished from the surface side to expose the plug electrode, and thereafter the second conductive layer is formed on the surface side of the second insulation film. Therefore, the thickness dimension of the plug electrode forming conductive film may be equal to or larger than the thickness dimension (depth dimension of the contact hole) of a part (first insulation film) of the insulation film interposed between the first conductive layer and the second conductive layer, and may be thin. Therefore, a film formation time of the plug electrode forming conductive film or a polishing time of the second insulation film can be shortened.

In an aspect of the invention, the second insulation film is preferably a silicate glass doped with at least one of phosphorous and boron. The silicate glass is porous and has hygroscopicity. Therefore, since the second insulation film removes moisture from the layer provided at a side opposite to the side on which the substrate body is located to the second conductive layer or the second conductive layer, the properties, reliability, and the like of the electrooptic device can be improved. The silicate glass doped with at least one of phosphorous and boron has excellent step coverage properties. Therefore, there is an advantage in that when the second insulation film is formed after forming the plug electrode, the side walls of the plug electrode are appropriately covered. Moreover, the silicate glass doped with at least one of phosphorous and boron has high polishing speed. Therefore, a polishing process can be efficiently performed.

In the method for manufacturing the electrooptic device according to the aspect of the invention, it is preferable that an aluminum-based metal film is formed, and then a barrier film is formed on an upper side of the aluminum-based metal film in the process for forming the plug electrode forming conductive film. In this case, in the electrooptic device according to the aspect of the invention, the plug electrode has a configuration of having the aluminum-based metal film and a barrier film laminated at a side opposite to the substrate to the aluminum-based metal film. According to the configuration, even when the second conductive layer contains a conductive oxide, for example, the barrier film contacts the conductive oxide in the plug electrode. Therefore, an increase in connection resistance resulting from contacting of the conductive oxide and the aluminum-based metal film or the like does not occur.

The invention is effective when applied to a case where the second conductive layer is a pixel electrode. In the case of a liquid crystal device, an alignment film is formed on the surface side of the pixel electrode. In the case of an organic electroluminescence device, a functional layer of the organic electroluminescence element is provided on the surface side of the pixel electrode. Herein, according to the aspect of the invention, an irregularity resulting from the contact hole is not formed in the surface side of the pixel electrode. Therefore, the invention can prevent the irregularity resulting from the contact hole from hindering the formation of the alignment film or the functional layer.

In the invention, when the electrooptic device is constituted as a liquid crystal device, a configuration is obtained in which a liquid crystal layer is held between the substrate and a counter substrate disposed facing the one surface side of the substrate.

The electrooptic device to which the invention is applied can be used in various display devices, such as a direct-view type display device, in various electronic devices. When the electrooptic device to which the invention is applied is a liquid crystal device, the electrooptic device (liquid crystal device) can be used for a projection display device. The projection display device has a light source portion emitting a lighting light to be emitted to the electrooptic device (liquid crystal device) to which the invention is applied and a projection optical system projecting light modulated by the liquid crystal device.

### BRIEF DESCRIPTION OF THE DRAWINGS

The invention will be described with reference to the accompanying drawings, wherein like numbers reference like elements.

FIG. 1 is a block diagram illustrating the electrical configuration of a liquid crystal device (electrooptic device) to which the invention is applied.

FIGS. 2A and 2B are explanatory views of a liquid crystal panel for use in the liquid crystal device to which the invention is applied.

FIGS. 3A and 3B are explanatory views of a pixel of the liquid crystal device to which the invention is applied.

FIG. 4 is an enlarged explanatory view of the cross-sectional configuration around a pixel electrode in the liquid crystal device to which the invention is applied.

FIGS. 5A to 5D are explanatory views of principal portions of a method for manufacturing the liquid crystal device to which the invention is applied.

FIGS. 6A to 6D are explanatory views of principal portions of the method for manufacturing the liquid crystal device to which the invention is applied.

FIGS. 7A and 7B are schematic configuration views of a projection display device employing the liquid crystal device to which the invention is applied.

FIGS. 8A to 8D are explanatory views of former problems.

### DESCRIPTION OF EXEMPLARY EMBODIMENTS

Embodiments of the invention are described with reference to the drawings. The following description mainly describes a case where the invention is applied to an electrically connected portion of a second electrode layer 7a and a pixel electrode 9a in a liquid crystal device and a method for manufacturing the same among various electrooptic devices. Therefore, in the following description, “the first conductive layer” in the invention is equivalent to the second electrode layer 7a and the “second conductive layer” in the invention is equivalent to the pixel electrode 9a. In the drawings referred to in the following description, the scale of each layer or each member is differentiated in order to make each layer or each member recognizable on the drawings. When the direction of a current flowing through a pixel transistor is reversed, a source and a drain are interchanged. However, in this description, a side (a source drain region at a pixel side) to which the pixel electrode is connected is regarded as a drain and a side (a source drain region at a data line side) to which a data line is connected is regarded as a source. When a layer formed on an element substrate is described, an upper side or a surface side refers to a side opposite to the side on which a substrate body is located (side on which a counter substrate is located) of an element substrate and a lower side refers to a side on which the substrate body is located of the element substrate.

### Description of Liquid Crystal Device: Electrooptic Device

### Entire Configuration

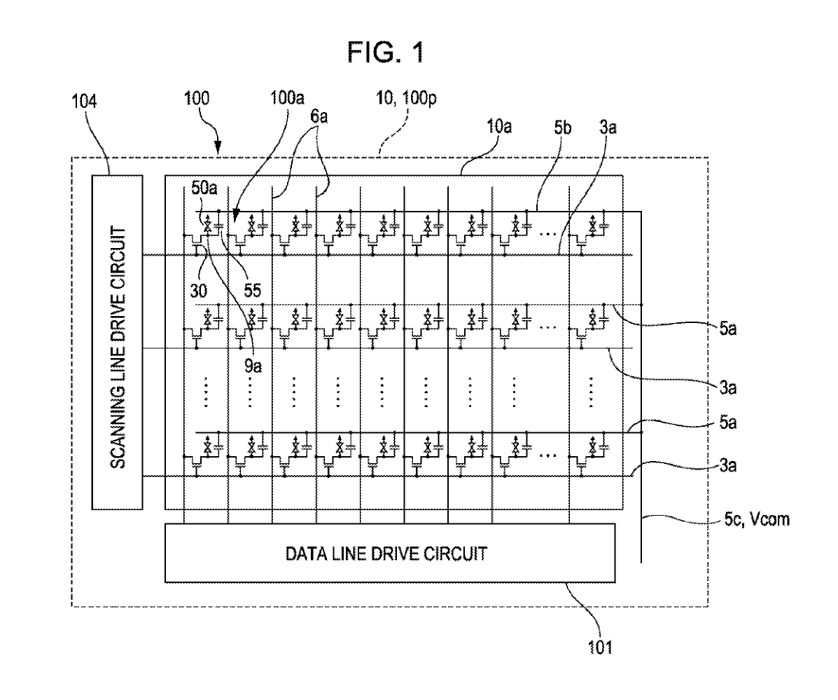

FIG. 1 is a block diagram illustrating the electrical configuration of a liquid crystal device to which the invention is applied. FIG. 1 is a block diagram strictly illustrating the electrical configuration, and therefore the layout, such as the direction in which a capacitance line and the like extend, is schematically illustrated.

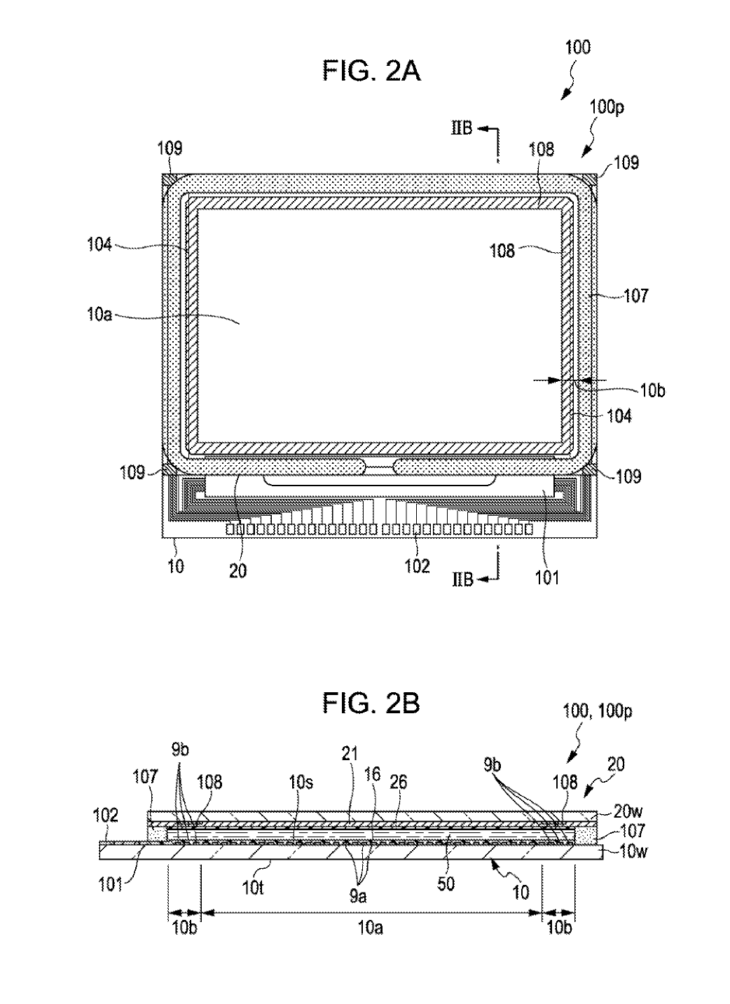

In FIG. 1, a liquid crystal device 100 of this aspect has a liquid crystal panel 100p of a TN (Twisted Nematic) mode or a VA (Vertical Alignment) mode. The liquid crystal panel 100p has an image display region 10a (pixel region) where a plurality of pixels 100a are arranged in the shape of a matrix in the central region thereof. In an element substrate 10 (e.g., FIG. 2) described later in the liquid crystal panel 100p, a plurality of data lines 6a and a plurality of scanning lines 3a vertically and horizontally extend inside the image display region 10a, and the pixels 100a are constituted at positions corresponding to the intersections thereof. In each of the plurality of the pixels 100a, a pixel transistor 30 containing a field effect transistor and a pixel electrode 9a described later are formed. The data line 6a is electrically connected to the source of the pixel transistor 30, the scanning line 3a is electrically connected to the gate of the pixel transistor 30, and the pixel electrode 9a is electrically connected to the drain of the pixel transistor 30.

In the element substrate 10, a scanning line drive circuit 104 and a data line drive circuit 101 are provided on the periphery of the image display region 10a. The data line drive circuit 101 is electrically connected to each data line 6a and sequentially supplies an image signal supplied from an image processing circuit to each data line 6a. The scanning line drive circuit 104 is electrically connected to each scanning line 3a and sequentially supplies a scanning signal to each scanning line 3a.

In each pixel 100a, the pixel electrode 9a faces a common electrode formed on a counter substrate 20 (e.g., FIG. 2) described later through a liquid crystal layer to constitute a liquid crystal capacitance 50a. In each pixel 100a, an accumulated capacitance 55 is added in parallel to the liquid crystal capacitance 50a in order to prevent a fluctuation of an image signal held by the liquid crystal capacitance 50a. In this aspect, in order to constitute the accumulated capacitance 55, a first electrode layer 5a over the plurality of pixels 100a is formed as a capacitance electrode layer. In this aspect, the first electrode layer 5a conducts to a common potential line 5c to which a common potential Vcom is applied.

### Configuration of Liquid Crystal Panel 100p

FIGS. 2A and 2B are explanatory views of the liquid crystal panel 100p for use in the liquid crystal device 100 to which the invention is applied. FIGS. 2A and 2B are a plan view of the liquid crystal panel 100p as viewed from the counter substrate side with constituent components and a cross sectional view taken along the IIB-IIB line thereof, respectively.

As illustrated in FIGS. 2A and 2B, in the liquid crystal panel 100p, the element substrate 10 (the element substrate for the electrooptic device) and the counter substrate 20 are stuck to each other by a seal material 107 with a given space, and the seal material 107 is provided in the shape of a frame along the outer edges of the counter substrate 20. The seal material 107 is an adhesive agent containing an optical curable resin, a thermosetting resin, or the like and a gap material, such as a glass fiber or glass beads, for maintaining a given distance between both the substrates is compounded.

In the liquid crystal panel 100p having such a configuration, the element substrate 10 and the counter substrate 20 all have a square shape, and the image display region 10a described with reference to FIG. 1 is provided as a square region almost at the center of the liquid crystal panel 100p. The seal material 107 is provided also in an approximately square shape corresponding to the shape, and an approximately square peripheral region 10b is provided in the shape of a frame between the inner peripheral edges of the seal material 107 and the outer peripheral edges of the image display region 10a. On the element substrate 10, the data line drive circuit 101 and a plurality of terminals 102 are provided along one side of the element substrate 10 and the scanning line drive circuit 104 is provided along other sides adjacent to the side on the periphery of the image display region 10a. To the terminals 102, a flexible wiring substrate (not illustrated) is connected and various potentials or various signals are input to the element substrate 10 through the flexible wiring substrate.

Although the details are described later, among one surface 10s and the other surface 10t of the element substrate 10, the pixel transistors 30 and the pixel electrodes 9a electrically connected to the pixel transistors 30 described with reference to FIG. 1 are formed in the shape of a matrix in the image display region 10a on the one surface 10s side and an alignment film 16 is formed on the upper side of the pixel electrodes 9a.

Moreover, on the one surface 10s side of the element substrate 10, dummy pixel electrodes 9b (FIG. 2B) simultaneously formed with the pixel electrodes 9a are formed in the peripheral region 10b. For the dummy pixel electrodes 9b, a configuration in which the dummy pixel electrodes 9b are electrically connected to dummy pixel transistors, a configuration in which a dummy pixel transistor is not provided and the dummy pixel electrodes 9b are directly and electrically connected to wiring, or a configuration in a float state in which a potential is not applied is adopted. When a surface on which the alignment film 16 is formed of the element substrate 10 is flattened by polishing, the dummy pixel electrodes 9b compresses the height position of the image display region 10a and the peripheral region 10b to thereby contribute to flattening the surface on which the alignment film 16 is formed. When the dummy pixel electrodes 9b are set to a given potential, a disorder of alignment of liquid crystal molecules at the outer peripheral side ends of the image display region 10a can be prevented.

On one surface side facing the element substrate 10 of the counter substrate 20, a common electrode 21 is formed and an alignment film 26 is formed on an upper portion of the common electrode 21. The common electrode 21 is formed on the approximately entire surface of the counter substrate 20 or over the plurality of pixels 100a as a plurality of strip electrodes. Moreover, on the one surface side facing the element substrate 10 of the counter substrate 20, a light-shielding layer 108 is formed on a lower side of the common electrode 21. In this aspect, the light-shielding layer 108 is formed in the shape of a frame extending along the outer peripheral edge of the image display region 10a and functions as a parting. Herein, the outer peripheral edges of the light-shielding layer 108 are located at positions with a space between the inner peripheral edges of the seal material 107, and the light-shielding layer 108 and the seal material 107 do not overlap with each other. On the counter substrate 20, the light-shielding layer 108 is sometimes formed as a black matrix portion in, for example, a region overlapping with an inter-pixel region sandwiched between the adjacent pixel electrodes 9a.

In the liquid crystal panel 100p thus configured, the element substrate 10 has inter-substrate conducting electrodes 109 for establishing electrical conducting between the element substrate 10 and the counter substrate 20 in regions overlapping with the corner portions of the counter substrate 20 on the periphery of the seal material 107. In the inter-substrate conducting electrodes 109, an inter-substrate conducting material 109a containing conductive particles is disposed. The common electrode 21 of the counter substrate 20 is electrically connected to the element substrate 10 side through the inter-substrate conducting materials 109a and the inter-substrate conducting electrodes 109. Therefore, a common potential Vcom is applied to the common electrode 21 from the element substrate 10 side. The seal material 107 is provided along the outer peripheral edge of the counter substrate 20 with the approximately same width dimension. Therefore, the seal material 107 has an approximately square shape. The seal material 107 is provided in such a manner as to avoid the inter-substrate conducting electrodes 109 and pass inside the same in the regions overlapping with the corner portions of the counter substrate 20, and therefore the corner portions of the seal material 107 have an approximately circular shape.

In the liquid crystal device 100 having such a configuration, when the pixel electrode 9a or the common electrode 21 is formed with a translucent conductive film of ITO, IZO, or the like, a transmission type liquid crystal device can be constituted. In contrast, when the common electrode 21 is formed with a translucent conductive film of ITO (Indium Tin Oxide), IZO (Indium Zinc Oxide), or the like and the pixel electrode 9a is formed with a reflective conductive film of aluminum or the like, a reflective liquid crystal device can be constituted. When the liquid crystal device 100 is a reflection type, light entering from the counter substrate 20 side is modulated while being reflected on the substrate on the element substrate 10 side and being emitted to display an image. When the liquid crystal device 100 is a transmission type, light entering from one substrate among the element substrate 10 and the counter substrate 20 is modulated while transmitting the other substrate and being emitted to display an image.

The liquid crystal device 100 can be used as a color display device of electronic devices, such as mobile computers and cellular phones. In this case, a color filter (not illustrated) or a protective film is formed on the counter substrate 20. In the liquid crystal device 100, a phase difference film, a polarizing plate, and the like are disposed in a given direction to the liquid crystal panel 100p in accordance with the type of the liquid crystal layer 50 to be used and the type of modes, i.e., a normally white mode or a normally black mode. Furthermore, the liquid crystal device 100 can be used as a light bulb for RGB in a projection display device (liquid crystal projector) described later. In this case, since each color light separated through a dichroic mirror for RGB color separation enters each liquid crystal device 100 for RGB as a projection light, a color filter is not formed.

This aspect mainly describes a case where the liquid crystal device 100 is a transmission type liquid crystal device used as a light bulb for RGB in a projection type display device described later and light entering from the counter substrate 20 transmits through the element substrate 10 to be emitted. Moreover, this aspect mainly describes a case where the liquid crystal device 100 has the liquid crystal panel 100p of a VA mode containing a nematic liquid crystal compound having a negative dielectric anisotropy as the liquid crystal layer 50.

### Specific Configuration of Pixel

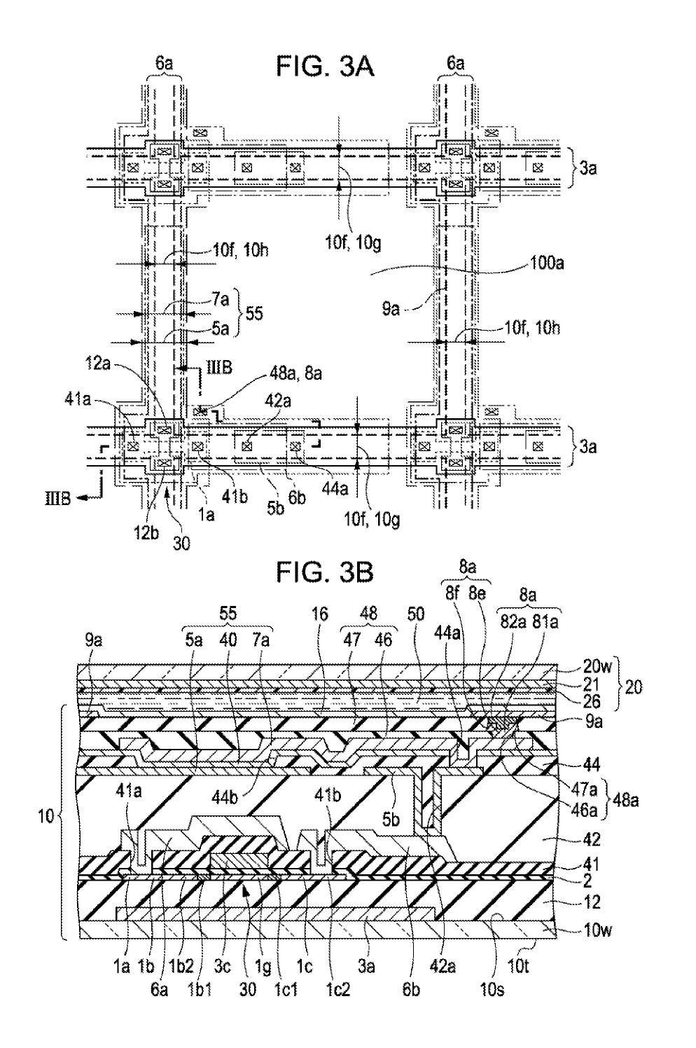

FIGS. 3A and 3B are explanatory views of the pixels of the liquid crystal device 100 to which the invention is applied. FIGS. 3A and 3B are a plan view of adjacent pixel on the element substrate 10 and a cross sectional view of the liquid crystal device 100 taken along the position equivalent to the IIIB-IIIB line of FIG. 3A, respectively. In FIG. 3A, each region is represented by the following line:

Scanning line 3a=Thick solid line,

Semiconductor layer 1a=Thin and short dotted line,

Data line 6a and Drain electrode 6b=Dashed line,

First electrode layer 5a and Relay electrode 5b=Thin and long broken line,

Second electrode layer 7a=chain double-dashed line,

Pixel electrode 9a=Thick and short broken line.

As illustrated in FIG. 3A, on the element substrate 10, rectangular pixel electrodes 9a are provided in each of the plurality of pixels 100a, and data lines 6a and scanning lines 3a are provided along regions overlapping with vertical and horizontal inter-pixel regions 10f sandwiched between the adjacent pixel electrodes 9a. More specifically, among the inter-pixel regions 10f, the scanning lines 3a extend along regions overlapping with first inter-pixel regions 10g extending along the scanning lines 3a and the data lines 6a extend along regions overlapping with second inter-pixel regions 10h extending along the data lines 6a. Each of the data lines 6a and the scanning lines 3a linearly extend and pixel transistors 30 are formed in regions where the data lines 6a and the scanning lines 3a cross each other. On the element substrate 10, the first electrode layer 5a (capacitance electrode layer) described with reference to FIG. 1 is formed in such a manner as to overlap with the data line 6a.

As illustrated in FIGS. 3A and 3B, the element substrate 10 is constituted mainly by a translucent substrate body 10w, such as a quartz substrate or a glass substrate, a pixel electrode 9a formed on the surface (one surface 10s side) on the side of a liquid crystal layer 50 of the substrate body 10w, a pixel transistor 30 for pixel switching, and an alignment film 16. The counter substrate 20 is constituted mainly by a translucent substrate body 20w, such as a quartz substrate or a glass substrate, a common electrode 21 formed on the surface (one surface side facing the element substrate 10) on the side of the liquid crystal layer 50, and an alignment film 26.

On the element substrate 10, the scanning line 3a containing a conductive film, such as a conductive polysilicon film, a metal silicide film, a metal film, or a metal film compound, is formed on one surface side of the substrate body 10w. In this aspect, the scanning line 3a is constituted by a light-shielding conductive films, such as tungsten silicide (WSiₓ), and functions also as a light-shielding film to the pixel transistor 30. In this aspect, the scanning line 3a contains tungsten silicide having a thickness of about 200 nm. Between the substrate body 10w and the scanning line 3a, an insulation film, such as a silicon oxide film, is sometimes provided.

On the one surface 10s side of the substrate body 10w, an insulation film 12, such as a silicon oxide film, is formed on the upper side of the scanning line 3a, and the pixel transistor 30 having a semiconductor layer 1a is formed on the surface of this insulation film 12. In this aspect, the insulation film 12 has a two-layer structure of a silicon oxide film formed by a decompression CVD method using tetraethoxysilane (Si(OC₂H₅)₄), a plasma CVD method using tetraethoxysilane and oxygen gas, or the like and a silicon oxide film (HTO (High Temperature Oxide) film) formed by a high temperature CVD method, for example.

The pixel transistor 30 has the semiconductor layer 1a having the long side direction in the extending direction of the scanning line 3a at the intersection region of the scanning line 3a and the data line 6a and the gate electrode 3c extending in a direction orthogonal to the length direction of the semiconductor layer 1a and overlapping with the central portion of the length direction of semiconductor layer 1a. The pixel transistor 30 has a translucent gate insulation layer 2 between the semiconductor layer 1a and the gate electrode 3c. The semiconductor layer 1a has a channel region 1g facing the gate electrode 3c through the gate insulation layer 2 and also a source region 1b and a drain region 1c at both ends of the channel region 1g. In this aspect, the pixel transistor 30 has an LDD structure. Therefore, the source region 1b and the drain region 1c have low concentration regions 1b1 and 1c1, respectively, at both sides of the channel region 1g and have high concentration regions 1b2 and 1c2, respectively, in regions opposite to the channel region 1g to the low concentration regions 1b1 and 1c1 and adjacent to the low concentration regions 1b1 and 1c1.

The semiconductor layer 1a is constituted by a polycrystalline silicon film or the like. The gate insulation layer 2 has a two-layer structure of a first gate insulation layer 2a containing a silicon oxide film obtained by thermally oxidizing the semiconductor layer 1a and a second gate insulation layer 2b containing a silicon oxide film or the like formed by a CVD method or the like. The gate electrode 3c contains a conductive film, such as a conductive polysilicon film, a metal silicide film, a metal film, or a metal film compound and conducts to the scanning line 3a at both sides of the semiconductor layer 1a through contact holes 12a and 12b penetrating the second gate insulation layer 2b and the insulation film 12. In this aspect, the gate electrode 3c has a two-layer structure of a conductive polysilicon film having a film thickness of about 100 nm and a tungsten silicide film having a film thickness of about 100 nm.

In this aspect, the scanning line 3a is formed with a light-shielding film for the purpose of preventing the occurrence of malfunction resulting from a photocurrent in the pixel transistor 30 when light after transmitting the liquid crystal device 100 is reflected on another component, and the reflected light enters the semiconductor layer 1a. A scanning line may be formed on the upper side of the gate insulation layer 2, and a part thereof may be used as the gate electrode 3c. In this case, the scanning line 3a illustrated in FIG. 3 is formed only for the purpose of shielding light.

On the upper side of the gate electrode 3c, a translucent interlayer insulation film 41 containing a silicon oxide film or the like is formed, and the data line 6a and the drain electrode 6b are formed on the upper side of the interlayer insulation film 41 with the same conductive film. The interlayer insulation film 41 contains a silicon oxide film or the like formed by a plasma CVD method or the like using silane gas (SH₄) and nitrous suboxide (N₂O), for example.

The data line 6a and the drain electrode 6b contain a conductive film, such as a conductive polysilicon film, a metal silicide film, a metal film, or a metal film compound. In this aspect, the data line 6a and the drain electrode 6b have a four-layer structure in which a titanium (Ti) film having a film thickness of 20 nm, a titanium nitride (TiN) film having a film thickness of 50 nm, an aluminum (Al) film having a film thickness of 350 nm, and a TiN film having a film thickness of 150 nm are laminated in this order. The data line 6a conducts to the source region 1b (data line side source drain region) through a contact hole 41a penetrating the interlayer insulation film 41 and the second gate insulation layer 2b. In a region overlapping with a first inter-pixel region 10g, the drain electrode 6b is formed in such a manner as to partially overlap with the drain region 1c (pixel electrode side source drain region) of the semiconductor layer 1a and conducts to the drain region 1c through a contact hole 41b penetrating the interlayer insulation film 41 and the second gate insulation layer 2b.

On the upper side of the data line 6a and the drain electrode 6b, a translucent interlayer insulation film 42 containing a silicon oxide film or the like is formed. The interlayer insulation film 42 contains a silicon oxide film or the like formed by a plasma CVD method or the like using tetraethoxysilane and oxygen gas, for example.

On the upper side of the interlayer insulation film 42, the first electrode layer 5a and the relay electrode 5b are formed with the same conductive film. The first electrode layer 5a and the relay electrode 5b contain a conductive film, such as a conductive polysilicon film, a metal silicide film, a metal film, or a metal film compound. In this aspect, the first electrode layer 5a and the relay electrode 5b have a two-layer structure of an Al film having a film thickness of about 200 nm and a TiN film having a film thickness of about 100 nm. The first electrode layer 5a extends along a region overlapping with a second inter-pixel 10h similarly as the data line 6a. In a region overlapping with the first inter-pixel region 10g, the relay electrode 5b is formed in such a manner as to partially overlap with the drain electrode 6b and conducts to the drain electrode 6b through a contact hole 42a penetrating the interlayer insulation film 42.

On the upper side of the first electrode layer 5a and the relay electrode 5b, a translucent interlayer insulation film 44, such as a silicon oxide film, is formed as an etching stopper layer. The interlayer insulation film 44 has an opening portion 44b formed in a region overlapping with the first electrode layer 5a. In this aspect, the interlayer insulation film 44 contains a silicon oxide film or the like formed by a plasma CVD method or the like using tetraethoxysilane and oxygen gas. Herein, although the illustration of the opening portion 44b is omitted in FIG. 3A, the opening portion 44b is formed in the shape of L having a portion extending along a region overlapping with the first inter-pixel region 10g with the intersection region of the data line 6a and the scanning line 3a as the starting point and a portion extending along a region overlapping with the second inter-pixel region 10h with the intersection region of the data line 6a and the scanning line 3a as the starting point.

On the upper side of the interlayer insulation film 44, a translucent dielectric layer 40 is formed. On the upper side of the dielectric layer 40, a second electrode layer 7a is formed. The second electrode layer 7a contains a conductive film, such as a conductive polysilicon film, a metal silicide film, a metal film, or a metal film compound. In this aspect, the second electrode layer 7a contains a TiN film having a film thickness of about 100 nm. As the dielectric layer 40, silicon compounds, such as a silicon oxide film or a silicon nitride film, can be used, and, in addition thereto, a dielectric layer with a high dielectric constant, such as an aluminum oxide film, a titanium oxide film, a tantalum film, a niobium oxide film, a hafnium oxide film, a lantern oxide film, and a zirconium oxide film, can also be used. The second electrode 7a is formed in the shape of L having a portion extending along a region overlapping with the first inter-pixel region 10g with the intersection region of the data line 6a and the scanning line 3a as the starting point and a portion extending along a region overlapping with the second inter-pixel region 10h with the intersection region of the data line 6a and the scanning line 3a as the starting point. Therefore, in the second electrode layer 7a, a portion extending along a region overlapping with the second inter-pixel region 10h overlaps with the first electrode layer 5a through the dielectric layer 40 in the opening portion 44b of the interlayer insulation film 44. Thus, in this aspect, the first electrode layer 5a, the dielectric layer 40, and the second electrode layer 7a constitute an accumulated capacitance 55 in the region overlapping with the first inter-pixel region 10g.

A portion extending along the region overlapping with the first inter-pixel region 10g in the second electrode layer 7a partially overlaps with the relay electrode 5b conducts to the relay electrode 5b through a contact hole 44a penetrating the dielectric layer 40 and the interlayer insulation film 44.

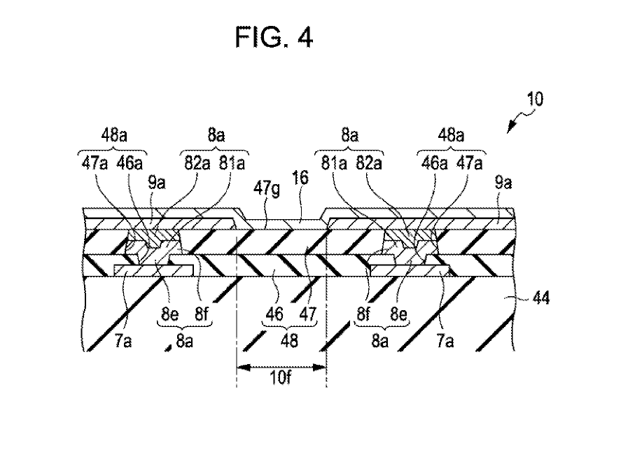

On the upper side of the second electrode layer 7a, a translucent interlayer insulation film 48 is formed. On the upper side of the interlayer insulation film 48, a pixel electrode 9a containing a translucent conductive film, such as an ITO film, is formed. The pixel electrode 9a partially overlaps with the second electrode layer 7a in the vicinity of the intersection region of the data line 6a and the scanning line 3a. In this aspect, the pixel electrode 9a conducts to the second electrode layer 7a through a plug electrode 8a embedded in the hole of the interlayer insulation film 48 as described later with reference to FIGS. 4 to 6. Also in this aspect, the interlayer insulation film 48 contains a lower first insulation film 46 and an upper second insulation film 47 and the pixel electrode 9a is formed on the surface of the second insulation film 47 as described later with reference to FIGS. 4 to 6.

The alignment film 16 is formed on the surface of the pixel electrode 9a. The alignment film 16 contains a resin film, such as polyimide, or an obliquely deposited film, such as a silicon oxide film. In this aspect, the alignment film 16 is an inorganic alignment film (vertical alignment film) containing an obliquely deposited film, such as SiOₓ (x<2), SiO₂, TiO₂, MgO, Al₂O₃, In₂O₃, Sb₂O₃, and Ta₂O₅.

On the counter substrate 20, the common electrode 21 containing a translucent conductive film, such as an ITO film, is formed on the surface (surface at a side facing the element substrate 10) on the side of the liquid crystal layer 50 of the translucent substrate body 20w, such as a quartz substrate or a glass substrate, and an alignment film 26 is formed in such a manner as to cover the common electrode 21. The alignment film 26 contains a resin film, such as polyimide, or an obliquely deposited film, such as a silicon oxide film, similarly as the alignment film 16. In this aspect, the alignment film 26 is an inorganic alignment film (vertical alignment film) containing an obliquely deposited film, such as SiOₓ (x<2), SiO₂, TiO₂, MgO, Al₂O₃, In₂O₃, Sb₂O₃, and Ta₂O₅. These alignment films 16 and 26 perpendicularly align the nematic liquid crystal compound having negative dielectric anisotropy used in the liquid crystal layer 50 and the liquid crystal panel 100p operates as a normally black VA mode.

In the data line drive circuit 101 and the scanning line drive circuit 104 described with reference to FIGS. 1 and 2, a complementary transistor circuit having an n channel type drive transistor and a p channel type drive transistor and the like are constituted. Herein, the drive transistors are formed utilizing a part of manufacturing processes of the pixel transistor 30. Therefore, the regions in which the data line drive circuit 101 and the scanning line drive circuit 104 are formed on the element substrate 10 also have the approximately same cross-sectional configuration as the cross-sectional configuration illustrated in FIG. 3B.

### Detailed Configuration Around Pixel Electrode 9a

FIG. 4 is an enlarged view of the cross-sectional configuration around the pixel electrode 9a in the liquid crystal device 100 to which the invention is applied.

As illustrated in FIG. 4, the translucent interlayer insulation film 48 is formed on the upper side of the second electrode layer 7a (first conductive layer) and the pixel electrode 9a (second conductive layer) containing a translucent conductive film, such as an ITO film, having a thickness of about 140 nm, is formed on the upper side of the interlayer insulation film 45. The alignment film 16 is formed on the surface side of the pixel electrode 9a.

In this aspect, the interlayer insulation film 48 has holes 48a penetrating the interlayer insulation film 48 to reach the second electrode layers 7a at positions overlapping with both the pixel electrodes 9a and the second electrode layers 7a, and plug electrodes 8a are provided in the holes 48a. Therefore, the pixel electrodes 9a are electrically connected to the second electrode layers 7a through the plug electrodes 8a. The surface of the interlayer insulation film 48 and the plug electrodes 8a constitute a continuous flat surface, and the pixel electrodes 9a are formed on the flat surface. Herein, a bore 48a of the interlayer insulation film 48 is not a straight bore formed by etching the interlayer insulation film 48 and contains a contact hole 46a of the first insulation film 46 and a bore 47a of the second insulation film 47.

More specifically, the interlayer insulation film 48 contains the first insulation film 46 formed on the surface side of the second electrode layer 7a and the second insulation film 47 laminated on the upper side of the first insulation film 46, and the surface of the second insulation film 47 constitutes the surface of the interlayer insulation film 48. The lower first insulation film 46 has contact holes 46a penetrating the first insulation film 46 at positions overlapping with both the pixel electrodes 9a and the second electrode layers 7a. The upper second insulation film 47 has holes 47a penetrating the second insulation film 47 at positions overlapping with the contact holes 46a. The contact hole 46a of the first insulation film 46 and the bore 47a of the second insulation film 47 constitute a lower half portion and an upper half portion of the bore 48a of the interlayer insulation film 48, respectively. In the second insulation film 47, a portion 47g formed in a region overlapping with the inter-pixel region 10f is exposed from the pixel electrode 9a and is in contact with the alignment film 16.

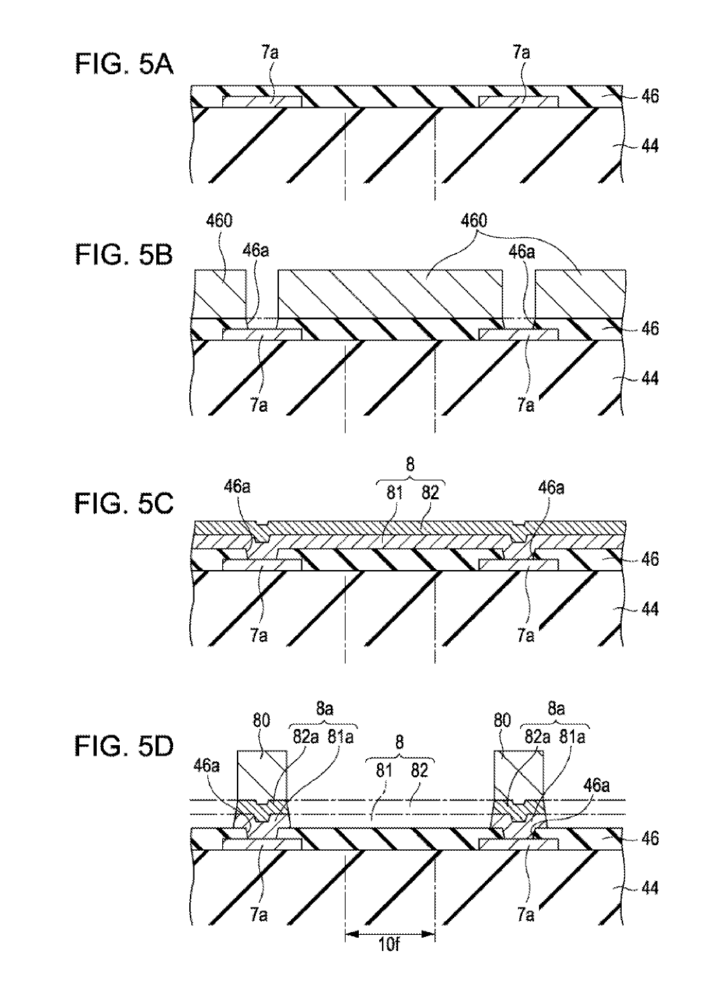

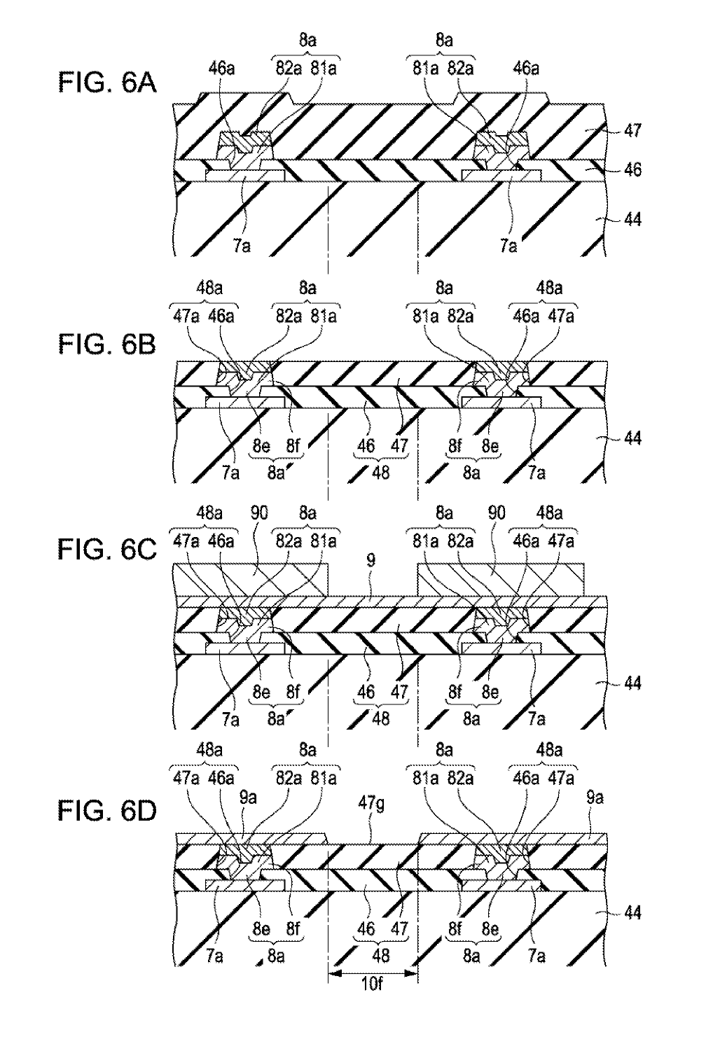

Herein, the contact hole 46a is a hole formed by etching the first insulation film 46. In contrast, the bore 47a is a hole generated by surrounding the circumference of the plug electrode 8a formed by patterning by the second insulation film 47 in a process described later with reference to FIGS. 5 and 6 and is not a hole formed by etching the second insulation film 47.

Thus, the contact hole 46a and the bore 47a are separately formed. In this aspect, the contact hole 46a and the bore 47a are different from each other in the shape. For example, the side walls of the contact hole 46a form an upwardly tapered surface. In contrast, the side walls of the bore 47a form a downwardly tapered surface. Corresponding to such a structure, the plug electrode 8a contains a first electrode portion 8e located inside the contact hole 46a and a second electrode portion 8f located inside the bore 47a, and the first electrode portion 8e and the second electrode portion 8f are different from each other in the shape. More specifically, the side walls of the first electrode portion 8e form a downwardly tapered surface corresponding to the side walls of the contact hole 46a and, in contrast thereto, the side walls of the second electrode portion 8f form an upwardly tapered surface corresponding to the side walls of the bore 47a. In this aspect, the inner diameter of the bore 47a is larger than the inter diameter of the contact hole 46a. Therefore, in the plug electrode 8a, the outer dimension of the second electrode portion 8f is larger than the outer dimension of the first electrode portion 8e.

In this aspect, the plug electrode 8a contains a laminated film of a conductive metal film and a metallic compound. More specifically, in this aspect, the lower side of the plug electrode 8a contains an aluminum-based metal film 81a, such as an aluminum simple substance film or an aluminum alloy and the upper side of the plug electrode 8a contains a barrier film 82a of TiN or the like. Accordingly, the surface of the barrier film 82a constitutes the surface of the plug electrode 8a. Therefore, in the plug electrode 8a, a barrier film 82a contacts the pixel electrode 9a and the aluminum-based metal film 81a contacts the second electrode layer 7a. In this aspect, the first electrode portion 8e contains an aluminum-based metal film 81a and the second electrode portion 8f has a two-layer structure of the aluminum-based metal film 81a and the barrier film 82a. Although a concave portion in accordance with an irregularity of the contact hole 46a arises in the surface of the aluminum-based metal film 81a, the surface of the barrier film 82a is a flat surface and constitutes a flat surface continuous to the surface of the interlayer insulation film 48.

In this aspect, the first insulation film 46 contains a silicon oxide film formed by a plasma CVD method using tetraethoxysilane and oxygen gas. The second insulation film 47 contains a silicate glass doped with at least one of phosphorous and boron. The second insulation film 47 is exposed from the pixel electrode 9a and contacts the alignment film 16 in the inter-pixel region 10f.

### Method for Manufacturing Liquid Crystal Device 100

FIGS. 5 and 6 are explanatory views of principal portions of the method for manufacturing the liquid crystal device 100 to which the invention is applied. The processes described below are performed in a state of a large-sized substrate capable of taking a large number of element substrates 10. The following description describes the same as the element substrate 10 irrespective of the size.

Among the manufacturing processes of the liquid crystal device 100 of this aspect, in a process for forming the element substrate 10, the interlayer insulation film 44 is formed by a well-known method, and then the second electrode layers 7a (first conductive layers) are formed in a first conductive layer formation process as illustrated in FIG. 5A. More specifically, a conductive film for forming the second electrode layers 7a is formed on the surface of the interlayer insulation film 44, and thereafter the conductive film is patterned to form the second electrode layers 7a.

Next, in a first insulation film formation process, the first insulation film 46 containing a silicon oxide film is formed on the surface side of the second electrode layers 7a by a plasma CVD method using tetraethoxysilane and oxygen gas. Next, the surface of the first insulation film 46 is polished to be flattened as required. In the polishing, chemical mechanical polishing can be utilized.

Next, in a contact hole formation process illustrated in FIG. 5B, the contact hole 46a is formed in the first insulation film 46. More specifically, a resist mask 460 is formed on the surface of the first insulation film 46 utilizing a photolithographic technique, and thereafter the first insulation film 46 is etched. Thereafter, the resist mask 460 is removed. As a result, the contact holes 46a penetrating the first insulation film 46 to reach the second electrode layers 7a are formed in the first insulation film 46. The side walls of the contact holes 46a contain an obliquely upwardly tapered surface.

Next, in a plug electrode forming conductive film formation process illustrated in FIG. 5C, a plug electrode forming conductive film 8 having a film thickness larger than that of the first insulation film 46 is formed by a sputtering method on the surface side of the first insulation film 46. In that case, the film thickness of the plug electrode forming conductive film 8 is larger than the thickness (depth of the contact hole 46a) of the first insulation film 46. In this aspect, the aluminum-based metal film 81, such as an aluminum simple substance film or an aluminum alloy, is formed by a sputtering method, a barrier film 82 of TiN or the like is formed on the upper side of the aluminum-based metal film 81 by a sputtering method, and then the plug electrode forming conductive film 8 having a two-layer structure of the aluminum-based metal film 81 and the barrier film 82 is formed.

Next, in a plug electrode formation process illustrated in FIG. 5D, the plug electrode forming conductive film 8 is patterned in such a manner that the plug electrode forming conductive film 8 remains at least in the contact holes 46a to form the plug electrodes 8a. In that case, the plug electrode 8a is patterned in such a manner as to be provide also on the periphery of the contact hole 46a as viewed in plan. More specifically, a resist mask 80 slightly widely covering a region overlapping with the contact hole 46a is formed on the surface of the plug electrode forming conductive film 8 utilizing a photolithographic technique, and thereafter the plug electrode forming conductive film 8 is etched, and thereafter the resist mask 80 is removed. As a result, the plug electrode forming conductive film 8 having a two-layer structure of the aluminum-based metal film 81a and the barrier film 82a is formed. The side walls of the plug electrode 8a contain an obliquely upwardly tapered surface.

Next, in a second insulation film formation process illustrated in FIG. 6A, the second insulation film 47 is formed on the surface side of the first insulation film 46 and the plug electrodes 8a. In that case, the second insulation film 47 is formed in such a manner as to cover the plug electrodes 8a. In this aspect, a silicate glass doped with at least one of phosphorous and boron is formed by a normal pressure CVD method or the like as the second insulation film 47. Among these kinds of silicate glass, the gas used in the case of forming a phosphorous doped silicate glass (PSG film) is SiH₄, PH₃, O₃, or the like. The gas used in the case of forming a boron doped silicate glass (BSG film) is SiH₄, B₂H₆, O₃, or the like. The gas used in the case of forming a boron and phosphorous doped silicate glass film (BPSG film) is SiH₄, B₂H₆, PH₃, O₃, or the like.

Next, in a polishing process illustrated in FIG. 6B, the second insulation film 47 is polished from the surface side to expose the plug electrodes 8a. In that case, the plug electrodes 8a are also partially polished. As a result, the interlayer insulation film 48 containing the first insulation film 46 and the second insulation film 47 is formed, and the surface (surface of the second insulation film 47) of the interlayer insulation film 48 and the surface of the plug electrodes 8a constitute a continuous flat surface. It is configured so that the holes 47a are formed in the second insulation film 47 by surrounding the circumference of the plug electrodes 8a and the plug electrodes 8a are provided in the holes 48a each containing the bore 47a and the contact hole 46a. The plug electrode 8a has the first electrode portion 8e located in the contact hole 46a and the second electrode portion 8f located in the bore 47a, and the second electrode portion 8f is patterned in such a manner as to be provided also at the outer side of the contact hole 46a as viewed in plan.

In this polishing process, chemical mechanical polishing can be utilized. In the chemical mechanical polishing, a smooth polished surface can be obtained with high speed by an action of chemical components contained in a polishing liquid and a relative displacement of a polishing agent and the element substrate 10. More specifically, in a polishing device, polishing is carried out by relatively rotating a platen to which a polishing cloth (pad) containing a nonwoven fabric, foamed polyurethane, porous fluororesin, or the like is stuck and a holder holding the element substrate 10. In that case, a polishing agent containing cerium oxide particles or colloidal silica having an average particle diameter of 0.01 to 20 μm, an acrylic ester derivative as a dispersant, and water, for example is supplied between the polishing cloth and the element substrate 10.

Next, in second conductive layer formation processes illustrated in FIGS. 6C and 6D, the pixel electrodes 9a (second conductive layers) conducting to the plug electrodes 8a are formed on the surface side of the second insulation film 47. More specifically, as illustrated in FIG. 6C, the translucent conductive film 9, such as an ITO film, constituting the pixel electrodes 9a is formed by a sputtering method or the like, a resist mask 90 is formed on the surface of the translucent conductive film 9 utilizing a photolithographic technique, the translucent conductive film 9 is etched, and thereafter the resist mask 90 is removed. As a result, as illustrated in FIG. 6D, the pixel electrode 9a is formed. In this state, a portion 47g formed in a region overlapping with the inter-pixel region 10f of the second insulation film 47 is exposed from the pixel electrodes 9a.

After an appropriate time, the alignment film 16 is formed as illustrated in FIG. 4. Processes following to the above-described processes can be performed utilizing well-known methods, and therefore the description thereof is omitted.

Main Effects of this Aspect

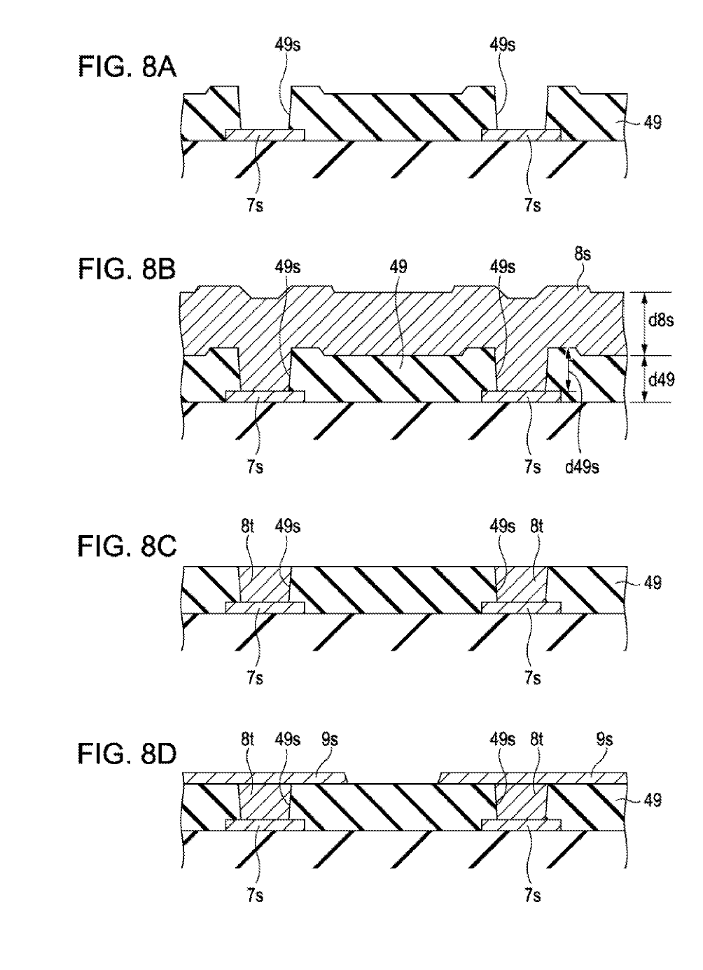

As described above, according to this aspect, when electrically connecting the second electrode layer 7a (first conductive layer) and the pixel electrode 9a (second conductive layer) through the plug electrode 8a provided in the bore 48a of the interlayer insulation film 48, the plug electrode 8a is formed in such a manner as to fill the contact hole 46a formed in the first insulation film 46, and then the second insulation film 47 is formed in this aspect. Then, the second insulation film 47 is polished from the surface side to expose the plug electrode 8a, and thereafter the pixel electrode 9a is formed on the surface side of the second insulation film 47. Therefore, the thickness dimension of the plug electrode forming conductive film 8 may be equal to or larger than the thickness dimension (depth size of the contact hole 46a) of a part (first insulation film 46) of the interlayer insulation film 48 interposed between the second electrode layer 7a and the pixel electrode 9a, and may be thin. Therefore, the film formation time of the plug electrode forming conductive film 8 and the polishing time of the second insulation film 47 can be shortened. In this aspect, the insulation film (second insulation film 47) is thickly formed as compared with the configuration described with reference to FIG. 8. However, since the CVD method for use in the film formation of the insulation film can be performed in a short time as compared with the sputtering method for use in the film formation of a metal film, the time of the entire process can be shortened.

Since the surface of the second insulation film 47 and the surface of the plug electrodes 8a constitute a continuous flat surface, the surface of the pixel electrodes 9a is also flat. Therefore, the alignment film 16 can be preferably formed. More specifically, since oblique deposition is performed to the flat surface when forming the alignment film 16 using inorganic materials, the alignment film 16 can be preferably formed. When the alignment film 16 is formed from organic materials, such as polyimide, the surface of the alignment film 16 is flat. Therefore, rubbing treatment can be properly performed. Therefore, the liquid crystal layer 50 can be preferably alignment, and the grade of an image displayed by the liquid crystal device 100 can be improved.

The second insulation film 47 is a silicate glass doped with at least one of phosphorous and boron and the silicate glass is porous and has hygroscopicity. A portion 47g formed in a region overlapping with the inter-pixel region 10f of the second insulation film 47 is exposed from the pixel electrodes 9a and is in contact with the alignment film 16. Therefore, when moisture is mixed in the liquid crystal layer 50 provided on the upper side of the pixel electrode 9a, the second insulation film 47 removes moisture from the liquid crystal layer 50 through the alignment film 16. Therefore, the properties, reliability, and the like of the liquid crystal device 100 can be improved. The silicate glass doped with at least one of phosphorous and boron has excellent step coverage properties, and therefore has an advantage of properly covering the side walls and the like of the plug electrodes 8a when forming the second insulation film 47 after forming the plug electrodes 8a. Moreover, since the silicate glass doped with at least one of phosphorous and boron has high polishing speed, the polishing process of the second insulation film 47 can be efficiently performed.

The plug electrode 8a has a lower aluminum-based metal film 81a and an upper barrier film 82a. Therefore, even when the pixel electrode 9a contains a conductive oxide, such as ITO, an increase in the connection resistance resulting from contacting of the conductive oxide and the aluminum-based metal film 81a or the like does not occur because the barrier film 82a contacts the conductive oxide in the plug electrode 8a.

In the plug electrode 8a, the outer dimension of the second electrode portion 8f is larger the outer dimension of the first electrode portion 8e. Therefore, conduction between the plug electrode 8a and the pixel electrode 9a can be certainly achieved.

### Other Embodiments

In the embodiment above, in the plug electrode 8a, the outer dimension of the second electrode portion 8f is larger the outer dimension of the first electrode portion 8e. However, a structure in which the outer dimension of the second electrode portion 8f and the outer dimension of the first electrode portion 8e are the same or a structure in which the outer dimension of the second electrode portion 8f is smaller than the outer dimension of the first electrode portion 8e may be adopted.

In the embodiment above, although the invention is applied to the conductive portion of the second electrode layer 7a and the pixel electrode 9a, the invention may be applied to other conductive portions utilizing the contact holes 41a, 41b, 42a, and 44a.

Although the embodiment above describes the example in which the invention is applied to the transmission type liquid crystal device 100, the invention may be applied to a reflective liquid crystal device 100.

Although the embodiment above described the example in which the invention is applied to the liquid crystal device 100, the invention may be applied to electrooptic devices other than liquid crystal device 100, such as an organic electroluminescence device.

### Configuration Example to Electronic Device

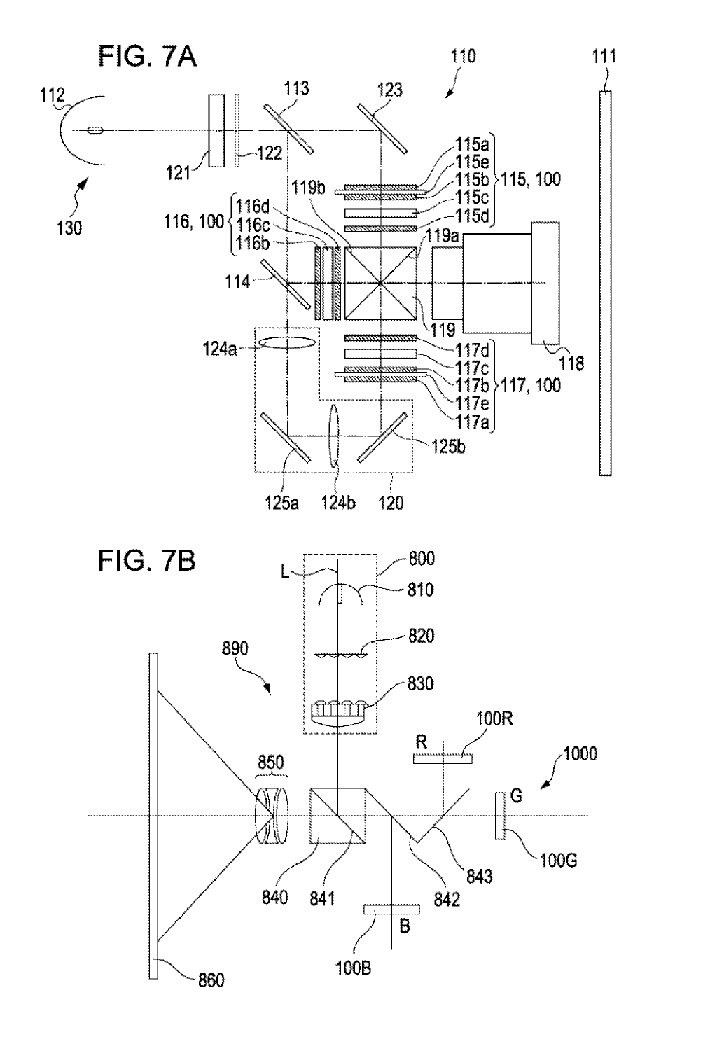

An electronic device having the liquid crystal device 100 according to the above-described embodiment is described. FIGS. 7A and 7B are schematic configuration diagrams of a projection display device employing the liquid crystal device 100 to which the invention is applied. FIGS. 7A and 7B are an explanatory view of a projection display device employing a transmission type liquid crystal device 100 and an explanatory view of the projection display device employing a reflective liquid crystal device 100, respectively.

### First Example of Projection Display Device

A projection display device 110 illustrated in FIG. 7A is a so-called projection type projection display device which irradiates a screen 111 provided on an observer side with light, and observes the light reflected on the screen 111. The projection display device 110 has a light source portion 130 having a light source 112, dichroic mirrors 113 and 114, liquid crystal light bulbs 115 to 117 (liquid crystal device 100), a projection optical system 118, a cross dichroic prism 119, and a relay system 120.

The light source 112 is constituted by an ultra-high pressure mercury lamp which supplies light containing red light, green light, and blue light. The dichroic mirror 113 has a configuration of transmitting the red light from the light source 112 and also reflecting the green light and the blue light. The dichroic mirror 114 has a configuration of transmitting the blue light among the green light and the blue light reflected on the dichroic mirror 113 and also reflecting the green light. Thus, the dichroic mirrors 113 and 114 constitute a color separation optical system which separates light emitted from the light source 112 to red light, green light, and blue light.

Herein, between the dichroic mirror 113 and the light source 112, an integrator 121 and a polarization conversion element 122 are disposed in this order from the light source 112. The integrator 121 has a configuration of equalizing the illumination distribution of the light emitted from the light source 112. The polarization conversion element 122 has a configuration of changing the light from the light source 112 to a polarized light having a specific oscillating direction such as, S-polarization, for example.

The liquid crystal light bulb 115 is a transmission type liquid crystal device 100 which modulates the red light which transmits through the dichroic mirror 113 and is reflected on a reflecting mirror 123 in accordance with an image signal. The liquid crystal light bulb 115 has a λ/2 phase difference plate 115a, a first polarizing plate 115b, a liquid crystal panel 115c, and a second polarizing plate 115d. Herein, even when the red light entering the liquid crystal light bulb 115 transmits through the dichroic mirror 113, the polarization of the light does not change, and therefore the polarization is still S-polarization.

The λ/2 phase difference plate 115a is an optical element which changes the S-polarization entering the liquid crystal light bulb 115 to P-polarization. The first polarizing plate 115b is a polarizing plate which blocks the S-polarization and transmits the P-polarization. The liquid crystal panel 115c has a configuration of changing the P-polarization to S-polarization (circular polarization or elliptical polarization in the case of a half tone) by modulation in accordance with an image signal. The second polarizing plate 115d is a polarizing plate which blocks P-polarization and transmits S-polarization. Therefore, the liquid crystal light bulb 115 has a configuration of modulating red light in accordance with an image signal, and emits the modulated red light to a cross dichroic prism 119.

The λ/2 phase difference plate 115a and the first polarizing plate 115b are disposed contacting a translucent glass substrate 115e which does not change the polarization, and can avoid the λ/2 phase difference plate 115a and the first polarizing plate 115b from distorting due to the generation of heat.

The liquid crystal light bulb 116 is a transmission type liquid crystal device 100 which modulates the green light, which is reflected on the dichroic mirror 113, and thereafter reflected on the dichroic mirror 114, in accordance with an image signal. The liquid crystal light bulb 116 has a first polarizing plate 116b, a liquid crystal panel 116c, and a second polarizing plate 116d similarly as the liquid crystal light bulb 115. The green light entering the liquid crystal light bulb 116 is S-polarization which is reflected on the dichroic mirrors 113 and 114 and enters. The first polarizing plate 116b is a polarizing plate which blocks P-polarization and transmits S-polarization. The liquid crystal panel 116c has a configuration of changing S-polarization to P-polarization (circular polarization or elliptical polarization in the case of a half tone) by modulation in accordance with an image signal. The second polarizing plate 116d is a polarizing plate which blocks S-polarization and transmits P-polarization. Therefore, the liquid crystal light bulb 116 has a configuration of modulating green light in accordance with an image signal, and emitting the modulated green light to the cross dichroic prism 119.

The liquid crystal light bulb 117 is the transmission type liquid crystal device 100 which modulates the blue light, which is reflected on the dichroic mirror 113, transmits through the dichroic mirror 114, and then passes through the relay system 120, in accordance with an image signal. The liquid crystal light bulb 117 has a λ/2 phase difference plate 117a, a first polarizing plate 117b, a liquid crystal panel 117c, and a second polarizing plate 117d similarly as the liquid crystal light bulbs 115 and 116. Herein, the blue light entering the liquid crystal light bulb 117 is S-polarization because the light is reflected on the dichroic mirror 113, transmits through the dichroic mirror 114, and then is reflected on the two reflecting mirrors 125a and 125b described later of the relay system 120.

The λ/2 phase difference plate 117a is an optical element which changes the S-polarization entering the liquid crystal light bulb 117 to P-polarization. The first polarizing plate 117b is a polarizing plate which blocks S-polarization, and transmits P-polarization. The liquid crystal panel 117c has a configuration of changing P-polarization to S-polarization (circular polarization or elliptical polarization in the case of a half tone) by modulation in accordance with an image signal. The second polarizing plate 117d is a polarizing plate which blocks P-polarization, and transmits S-polarization. Therefore, the liquid crystal light bulb 117 has a configuration of modulating blue light in accordance with an image signal, and emitting the modulated blue light to the cross dichroic prism 119. The λ/2 phase difference plate 117a and the first polarizing plate 117b are disposed contacting a glass plate 117e.

The relay system 120 has relay lenses 124a and 124b and reflecting mirrors 125a and 125b. The relay lenses 124a and 124b are provided in order to prevent optical loss due to the fact that the optical path of blue light is long. Herein, the relay lens 124a is disposed between the dichroic mirror 114 and the reflecting mirror 125a. The relay lens 124b is disposed between the reflecting mirrors 125a and 125b. The reflecting mirror 125a is disposed in such a manner as to reflect the blue light, which transmits through the dichroic mirror 114 and is emitted from the relay lens 124a, on the relay lens 124b. The reflecting mirror 125b is disposed in such a manner as to reflect the blue light, which is emitted from the relay lens 124b, on the liquid crystal light bulb 117.

The cross dichroic prism 119 is a color synthesizing optical system in which two dichroic films 119a and 119b are disposed orthogonal to each other in the shape of X. The dichroic film 119a is a film which reflects blue light and transmits green light. The dichroic film 119b is a film which reflects red light and transmits green light. Therefore, the cross dichroic prism 119 is configured in such a manner as to synthesize red light, green light, and blue light which are modulated by each of the liquid crystal light bulbs 115 to 117, and then emit the same to the projection optical system 118.

The light entering the cross dichroic prism 119 from the liquid crystal light bulbs 115 and 117 is S-polarization. The light entering the cross dichroic prism 119 from the liquid crystal light bulb 116 is P-polarization. Thus, since the type of the polarization of each light entering the cross dichroic prism 119 is differentiated, the light entering from each of the liquid crystal light bulb 115 to 117 can be synthesized in the cross dichroic prism 119. Herein, the dichroic films 119a and 119b are generally excellent in reflection transistor properties of S-polarization. Therefore, the red light and the blue light reflected on the dichroic films 119a and 119b are S-polarization and the green light transmitting through the dichroic films 119a and 119b is P-polarization. The projection optical system 118 has a projection lens (not illustrated) and is configured in such a manner as to project the light synthesized in the cross dichroic prism 119 on the screen 111.

### Second Example of Projection Display Device

In a projection display device 1000 illustrated in FIG. 7B, a light source portion 890 has a polarization illuminator 800 having a light source 810, an integrator lens 820, and a polarization conversion element 830 disposed along a system optical axis L. The light source portion 890 has a polarization beam splitter 840 which reflects an S polarized light flux emitted from the polarization illuminator 800 on an S polarized light flux reflecting surface 841, a dichroic mirror 843 which separates components of blue light (B) among the lights reflected from the S polarized light flux reflective surface 841 of the polarization beam splitter 840, and a dichroic mirror 842 which reflects and separates components of red light (R) among the light flux after the blue light is separated along the system optical axis L.

The projection display device 1000 has three reflective liquid crystal devices 100 (liquid crystal devices 100R, 100G, and 100B) which each color light enters. The light source portion 890 supplies a given color light to each of the three liquid crystal devices 100 (liquid crystal devices 100R, 100G, and 100B).

In the projection display device 1000, the lights modulated in the three liquid crystal devices 100R, 100G and 100B are synthesized in the dichroic mirrors 842 and 843 and the polarization beam splitter 840, and then the synthesized light is projected onto a projection target member, such as a screen 860, by a projection optical system 850.

### Other Projection Display Devices

The projection display device may be configured so that an LED light source or the like emitting each color light is used as the light source portion and each color light emitted from the LED light source is supplied to different liquid crystal devices.

### Other Electronic Devices

The liquid crystal device 100 to which the invention is applied may be used, in addition to the above-described electronic device, in electronic devices, such as cellular phones, information personal digital assistants (PDA: Personal Digital Assistants), digital cameras, liquid crystal televisions, car navigation devices, TV phones, POS terminals, and apparatuses having a touch panel, as a direct-view type display device.

The entire disclosure of Japanese Patent Application No. 2011-073545, filed Mar. 29, 2011 is expressly incorporated by reference herein.

What is claimed is:

1. An electrooptic device, comprising:
a first conductive layer provided on a substrate;
a first insulation film provided at a side opposite to the substrate to the first conductive layer and having a contact hole which reaches the first conductive layer;
a plug electrode having a first electrode portion filling the inside of the contact hole and a second electrode portion projecting from the surface of the first insulation film;
a second insulation film provided at a side opposite to the substrate to the first insulation film and constituting a continuous flat surface with the plug electrode; and
a second conductive layer provided at a side opposite to the substrate to the second insulation film and conducting to the plug electrode,
the second electrode portion being patterned in such a manner as to be provided on the periphery of the contact hole as viewed in plan.

2. The electrooptic device according to claim 1, wherein the second insulation film is a silicate glass doped with at least one of phosphorous and boron.

3. The electrooptic device according to claim 1, wherein the plug electrode has an aluminum-based metal film and a barrier film laminated at a side opposite to the substrate to the aluminum-based metal film.

4. The electrooptic device according to claim 1, wherein the second conductive layer is a pixel electrode.

5. The electrooptic device according to claim 1, wherein a liquid crystal layer is held between the substrate and a counter substrate disposed facing the one surface side of the substrate.

6. A projection display device having the electrooptic device according to claim 1,
the projection display device, comprising:
a light source portion emitting a lighting light to be emitted to the electrooptic device; and
a projection optical system projecting light modulated by the liquid crystal device.

7. An electronic device, comprising the electrooptic device according to claim 1.
